(19) United States
(12) Patent Application Publication
(10) Pub. No.: US 2020/0342767 A1
(43) Pub. Date: Oct. 29, 2020

(54) Platform and method for monitoring an infrastructure for transport vehicles, related vehicle, transport system and computer program

(71) Applicant: TRANSDEV GROUP, Issy Les Moulineaux (FR)

(72) Inventors: Kien Cuong NGUYEN, Antony (FR); Alexis BEAUVILLAIN, Massy (FR)

(21) Appl. No.: 16/856,669

(22) Filed: Apr. 23, 2020

(30) Foreign Application Priority Data
Apr. 26, 2019 (FR) 19 04475

(51) Int. Cl. G08G 1/00; G05D 1/02; G08G 1/01

(52) U.S. Cl. CPC G08G 1/22; G08G 1/0112; G05D 1/0295; G05D 1/0293

(57) ABSTRACT

A platform (14) for monitoring an infrastructure for transport vehicles (12_{A}), in particular autonomous transport vehicles, the platform (14) comprising a synthesis tool (28) comprising at least: a first receiving and processing module (30) configured to receive and process at least one monitoring information item by road, each monitoring information item by road being determined from a tracking list by road including several information elements associated with a traffic element detected via a sensor installed along the public road network of the infrastructure, and; a second receiving and processing module (32) configured to receive and process at least one monitoring information item by vehicle, each monitoring information item by vehicle being determined from a tracking list by vehicle including several information elements associated with a traffic element detected via a sensor installed on board a vehicle traveling on the infrastructure.

This application claims priority to French Patent Application No. 19 04475 filed Apr. 26, 2020, the entire disclosure of which is incorporated by reference herein.

The present invention relates to a platform for monitoring an infrastructure for transport vehicles, in particular autonomous transport vehicles.

The invention also relates to a transport system comprising a fleet of vehicles able to move on an infrastructure for transport vehicles, the fleet of vehicles comprising at least one target vehicle able to follow a predefined path on the infrastructure.

The invention also relates to a method for monitoring an infrastructure for transport vehicles, in particular autonomous transport vehicles, the method being implemented by such a monitoring platform of the infrastructure.

The invention also relates to a computer program including software instructions which, when executed by a computer, implement such a monitoring method.

The invention relates to the field of monitoring a fleet of transport vehicles on an infrastructure, in particular road or rail, and particularly the field of the automated driving of autonomous transport vehicles.

Indeed, in the field of this secure driving of motor vehicles, and in particular in autonomous driving, one of the main problems is the early identification of obstacles on the path of a moving vehicle, making it possible to take corrective measures so that the vehicle does not hit these obstacles and/or changes its itinerary in order to avoid them.

The obstacles in question are of any type, for example stationary obstacles, such as guardrails, parked vehicles, or moving obstacles, for example other vehicles or pedestrians. It will be understood that it is critical to avoid any collision between a moving vehicle and such obstacles.

Vehicles are known that are each equipped with at least one obstacle detection module configured to detect any obstacle entering its field of view. However, such obstacle detection implemented by the vehicle alone is limited by the field of view of the obstacle detection module that it comprises.

Collective perception driver assistance systems are known comprising communication devices able to identify obstacles in a traffic area via sensors, installed along the public road network and/or embedded in a plurality of separate vehicles, and able to inform a remote monitoring platform thereof. The remote monitoring platform is able to determine and send a setpoint to a vehicle traveling in said road traffic area as a function of different information items received via such a collective perception system.

However, these collective perception systems inform the remote monitoring platform most often via information items specific to the technology of each sensor making them up, which makes the processing carried out by the supervision platform complex and slower, the platform receiving information of types as varied as the types of sensors implemented.

In other words, for a human operator, located within the remote monitoring platform of a traffic area to be monitored, the processing of these information items associated with the different information sources (that is to say, sensors) is complex. Indeed, called upon to process each information item differently as a function of the type of sensor from which each information item is obtained, the processing done by the human operator is tedious and, above all, time-consuming to make a decision based on the encountered traffic situation, and once this decision is established, it is often no longer relevant and/or applicable because the traffic situation has changed during the time needed to obtain it.

The aim of the invention is to address the drawbacks of the state of the art by proposing a remote monitoring platform that is more effective, and faster to better anticipate any obstruction, in particular temporary, of the field of view of an obstacle detection module embedded on a target vehicle, in particular autonomous, to be assisted on its path.

To that end, the invention relates to a platform for monitoring an infrastructure for transport vehicles, in particular autonomous transport vehicles, the platform comprising a synthesis tool comprising at least:
a first receiving and processing module configured to receive and process at least one monitoring information item by road, each monitoring information item by road being determined from a tracking list by road including several information elements associated with a traffic element detected via a sensor installed along the public road network of the infrastructure, and
a second receiving and processing module configured to receive and process at least one monitoring information item by vehicle, each monitoring information item by vehicle being determined from a tracking list by vehicle including several information elements associated with a traffic element detected via a sensor installed on board a vehicle traveling on the infrastructure.

Thus, the supervision platform, due to its structure provided with a synthesis tool according to the invention, is able to receive and process automatically (that is to say, without human intervention), information generated from different sources, namely a source (that is to say, sensor) on the road and a source (that is to say, sensor) embedded on a vehicle, but determined from a same format, namely a tracking list, this format being particularly suitable for the supervision of static or dynamic traffic element(s) able to constitute an obstacle on a predefined path of an autonomous vehicle, for example.

Wth such format uniformity used to generate the received information, the overall monitoring processing of an infrastructure implemented by the supervision platform is simplified and accelerated, since the synthesis tool is able to receive and process, automatically, information items obtained from tracking lists generated from different sources (that is to say, sensors), namely a source on the road and a source embedded on a vehicle. In other words, the monitoring reactivity of the remote monitoring platform is increased, which makes it possible to increase the relevance and the effectiveness of the decision-making by a human operator located within the monitoring platform and capable, owing to the invention, of better apprehending the current traffic situation. Thus, the synthesis tool according to the present invention is a decision assistance tool.

According to other advantageous aspects of the invention, the monitoring platform comprises one or more of the following features, considered alone or according to any technical possible combinations:
the synthesis tool further comprises a display module configured to display, simultaneously in an image representative of at least part of the infrastructure:
   at least one road perception, representative of the state of the traffic element associated with said at least one monitoring information item by road, the road perception being determined from said at least one monitoring information item by road, and
   at least one vehicle perception, representative of the state of the traffic element associated with said at least one monitoring information item by vehicle, the vehicle perception being determined from said at least one monitoring information item by vehicle, and
the display module is configured to provide a dynamic display able to update in case of variation exceeding a predetermined threshold of the value of said at least one monitoring information item by road received between two separate instants or the value of said at least one monitoring information item by vehicle received between two separate instants;
the synthesis tool further comprises a synchronization module configured to synchronize said at least one monitoring information item by road and said at least one monitoring information item by vehicle when they are associated with the same traffic element;
the tracking list associated with said at least one monitoring information item by road and/or the tracking list associated with said at least one monitoring information item by vehicle comprises a plurality of information items chosen from the group consisting of:
   the type of traffic element,
   the position of the traffic element,
   at least one dimension of the traffic element;
   a speed of the traffic element; and
   a confidence index associated with the traffic element;
said at least one received monitoring information item by road corresponds:
   directly to at least part of the tracking list by road with which said at least one received monitoring information item by road is associated, or
   to a movement limiting setpoint for each vehicle located in a geographical area in which the traffic element is located associated with said at least one monitoring information item by road, the movement limiting setpoint being calculated as a function of at least the tracking list by road with which said at least one received monitoring information item by road is associated,
and/or wherein said at least one received monitoring information item by vehicle corresponds:
   directly to at least part of the tracking list by vehicle with which said at least one received monitoring information item by vehicle is associated, or
   to a movement limiting setpoint for each vehicle located in a geographical area in which the traffic element is located associated with said at least one monitoring information item by vehicle, the movement limiting setpoint being calculated as a function of at least the tracking list by vehicle with which said at least one received monitoring information item by vehicle is associated;
the platform further comprises a module for generating and sending an instruction to a target vehicle able to follow a predefined path on the infrastructure, the instruction being determined from said at least one monitoring information item by road and from said at least one monitoring information item by vehicle.

The invention also relates to a transport system comprising a fleet of vehicles able to move on an infrastructure for transport vehicles, the fleet of vehicles comprising at least one target vehicle able to follow a predefined path on the infrastructure, the transport system further comprising such a monitoring platform according to the invention.

The invention also relates to a method for monitoring an infrastructure for transport vehicles, in particular autonomous transport vehicles, the method being implemented by a synthesis tool of a monitoring platform of the infrastructure, the method comprising:
a first step for receiving and processing at least one monitoring information item by road, each monitoring information item by road being determined from a tracking list by road including several information elements associated with a traffic element detected via a sensor installed along the public road network of the infrastructure,
a second step for receiving and processing at least one monitoring information item by vehicle, each monitoring information item by vehicle being determined from a tracking list by vehicle including several information elements associated with a traffic element detected via a sensor installed on board a vehicle traveling on the infrastructure.

The invention also relates to a computer program including software instructions which, when executed by a computer, implement such a monitoring method.

These features and advantages of the invention will appear more clearly upon reading the following description, provided solely as a non-limiting example, and done in reference to the appended drawings, in which:

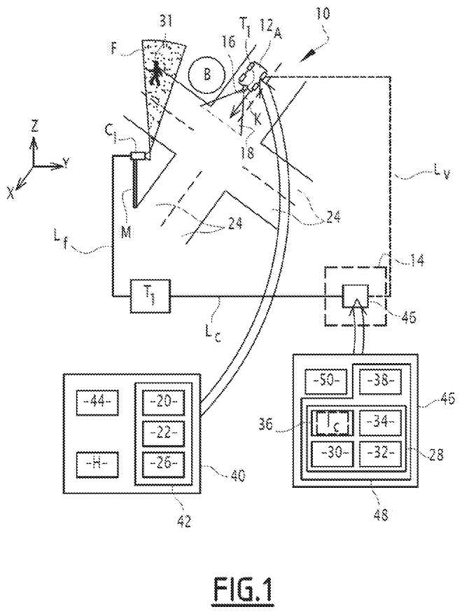

FIG. 1 is a schematic illustration of a transport system according to the invention in a monitoring situation;

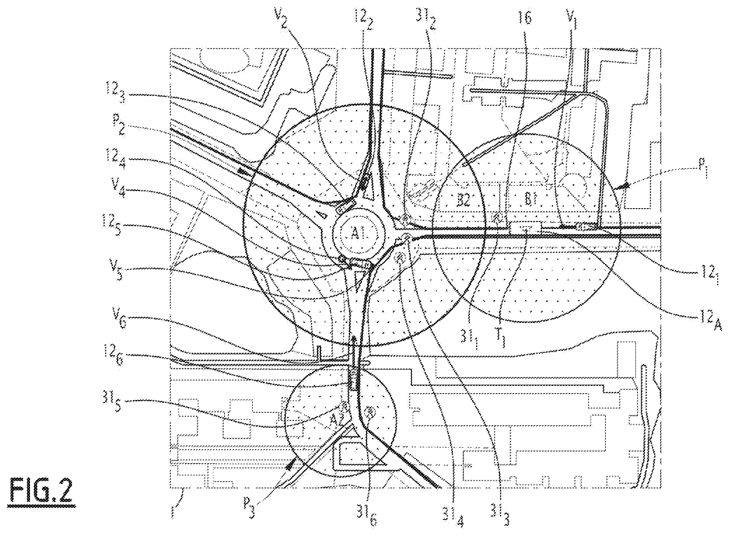

FIG. 2 is an exemplary synthetic image produced by the synthesis tool of the monitoring platform according to the invention; and

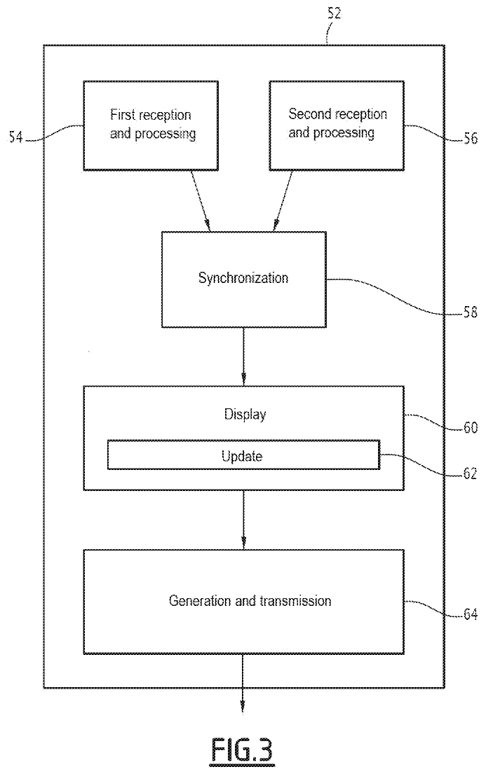

FIG. 3 is a flowchart of a supervision method according to the invention.

In the remainder of the description, the expression “substantially equal to” refers to a relationship of equality to within plus or minus 10%, preferably to within plus or minus 5%.

In FIG. 1, a transport system 10 comprises a fleet of vehicles 12, a monitoring platform 14 and a plurality of sensors, installed in the road like the sensor C₁ and/or embedded on a plurality of separate vehicles like the obstacle detection module (that is to say, sensor) 16.

Each sensor (that is to say, obstacle detection module) C₁ or 16 is associated with an electronic communication device (that is to say, terminal) T₁ comprising at least one sending module configured to transmit monitoring information by road or by vehicle according to the location of the considered sensor.

According to a first variant, each sensor is associated with its own communication terminal (that is to say, electronic device) in order to form a monitoring apparatus together.

According to a second variant (not shown), several sensors are associated with a same electronic communication device T₁.

Each monitoring apparatus installed in the road is for example attached to a vertical mast M, like in the example of FIG. 1, or to a building B. Each monitoring apparatus installed on a motor vehicle is preferably attached to the front of the motor vehicle 12_{A} or on the roof of said vehicle 12_{A}.

Among the fleet of vehicles 12, at least one vehicle 12 is an autonomous vehicle and is then denoted 12_{A}. The fleet preferably includes a plurality of vehicles 12, each vehicle preferably being an autonomous vehicle 12_{A}.

In the example of FIG. 1, the autonomous vehicle 12_{A} is an autonomous car, an autonomous bus, an autonomous tram, an autonomous train, or any other autonomous public means of transportation, etc.

Such an autonomous vehicle 12_{A} comprises, in a known manner, front wheels, rear wheels, an engine (not shown) mechanically coupled via a transmission chain to the front and/or rear wheels for the driving of said wheels in rotation about their axis, a steering system (not shown), suitable for acting on the front and/or rear wheels of the autonomous vehicle 12_{A}, so as to change the orientation of its path, and a braking system (not shown), suitable for exerting a braking force on the wheels of the autonomous vehicle 12_{A}.

One skilled in the art will then understand that the vehicle 12_{A} is shown in top view in the schematic view of FIG. 1, the black rectangles symbolizing the wheels of this autonomous vehicle 12_{A}.

According to the invention, such an autonomous vehicle 12_{A} is provided with at least one obstacle detection module 16, the field of view 18 of which is predetermined and known by the monitoring platform 14.

Such an obstacle detection module 16 for example comprises one or several sensors embedded within the vehicle corresponding to an image sensor, that is to say, a photo sensor or a camera or chosen from the group of sensors comprising at least: a lidar (light detection and ranging), a leddar (light-emitting diode detection and ranging), a radar (radio detection and ranging) and an ultrasonic sensor.

Additionally, as illustrated in FIG. 1, the autonomous vehicle 12_{A} comprises a geolocation module 20, a clock H and an autonomous driving module 22.

A geolocation module 20 hereinafter refers to an instrument capable of positioning the autonomous vehicle 12_{A} on a plane or a map using its geographical coordinates. Such a geolocation module 20 is able to be located, for example using a satellite positioning system, to receive its geographical position in real time, for example via a GPS receiver, and to broadcast it in real time.

Other geolocation techniques are usable according to the invention, such as geolocation by geocoder, GSM, use of an inertial unit, a radar or a lidar.

Such geolocation techniques are, according to one specific aspect of the invention, optimized by a map matching technique or a simultaneous localization and mapping (SLAM) technique.

According to one specific aspect of the invention, the geolocation module 20 and the clock H are according to an ASIL (Automotive Safety Integrity Level) D, such an ASIL D representing the maximum degree of rigor required to ensure the safety requirements associated with a maximum danger level. The ASIL is by definition obtained by multiplication of a triplet of values respectively representative of three safety criteria, namely severity, exposure and controllability.

In other words, as of the design of the autonomous vehicle 12_{A} according to the present invention, the maximum level of precision in terms of temporal indication(s), or timestamped data, delivered by the clock H and in terms of geographical geolocation precision of the autonomous vehicle 12_{A} delivered by the geolocation module 20 is required.

Hereinafter, autonomous driving module 22 refers to a logic controller suitable for driving the autonomous vehicle autonomously by receiving information on the environment of the autonomous vehicle 12A by means of sensors, located outside or inside the autonomous vehicle, and acting on the engine (not shown), the steering system (not shown) and the braking system (not shown) so as to modify the speed and the path of the autonomous vehicle 12_{A} in response to the received information and so as to comply with a mission programmed into the logic controller.

In particular, such a mission corresponds to following a predefined path, for example the path followed by a bus or tram line or any other autonomous means of public transportation on one or several traffic lanes 24, visible in FIG. 1, and able to meet at an intersection near a building B that may for example obstruct the field of view of the sensor 16.

When the motor vehicle 12 is an autonomous motor vehicle, it preferably has a level of automation greater than or equal to 3 according to the scale of the International Organization of Motor Vehicle Manufacturers (OICA). The level of automation is then equal to 3, that is to say, conditional automation, or equal to 4, that is to say, high automation, or equal to 5, that is to say, full automation.

According to the OICA, level 3 for conditional automation corresponds to a level for which the driver does not need to monitor dynamic driving continuously, or the driving environment, while still having to be able to take back control of the autonomous motor vehicle. According to this level 3, a system for managing the autonomous driving, embedded in the autonomous motor vehicle 12A, then performs the longitudinal and lateral driving in a defined usage scenario and is able to recognize its performance limitations to then ask the driver to take back dynamic driving with a sufficient time margin.

Level 4 for high automation corresponds to a level for which the driver is not required in a defined usage case. According to this level 4, the system for managing the autonomous driving, embedded in the autonomous motor vehicle 12A, then performs the lateral and longitudinal driving in all situations of this defined usage scenario.

Level 5 for full automation lastly corresponds to a level for which the autonomous driving management system, embedded on the autonomous motor vehicle, performs the dynamic lateral and longitudinal driving in all situations encountered by the autonomous motor vehicle, throughout its entire journey. No driver is then required.

Furthermore, the autonomous vehicle 12_{A} comprises a reception and processing module 26 configured to receive, via the dedicated link L_{V} (optionally secure), and process a driving setpoint sent by the monitoring platform 14. Such a setpoint in particular corresponds to an order, or even a deceleration value or a change of path, and is subsequently transferred by the receiving module 26 to the autonomous driving module 22 for processing and/or application.

The monitoring platform 14 is an electronic equipment item able to monitor remotely, or even control remotely, the fleet of motor vehicle(s) 12, the monitoring platform also being called CCP (acronym for Central Control Point).

According to the invention, the monitoring platform 14 comprises a synthesis tool 28 able to deliver a synthesis result, for at least part of the infrastructure monitored by the monitoring platform 14, from the set of received information items.

To that end, the synthesis tool 28 comprises both a first receiving and processing module 30 configured to receive and process at least one monitoring information item by road, each monitoring information item by road being determined from a tracking list by road including several information elements associated with a traffic element 31 detected via a sensor installed along the public road network of the infrastructure, and a second receiving and processing module 32 configured to receive and process at least one monitoring information item by vehicle, each monitoring information item by vehicle being determined from a tracking list by vehicle including several information elements associated with a traffic element detected via a sensor installed on board a vehicle traveling on the infrastructure.

Each tracking list includes several information elements. Each information element is timestamped and for example chosen from the group consisting of:
the type of traffic element 31, such as a moving or stopped pedestrian as illustrated by FIG. 1, a group of pedestrians, a stationary obstacle such as traffic congestion, a worksite or restricted traffic area, a natural obstacle, such as a tree, a branch, an animal, a motor vehicle, a bicycle, a weather phenomenon, etc.;
the position of the traffic element 31;
at least one dimension of the traffic element 31;
a speed of the traffic element 31; and
a confidence index associated with the traffic element 31;
the description of the field of view of the source sensor for example corresponding to the coordinates of the area (that is to say, field of view) monitored by such a sensor;
the classification of the sensor, such as road, embedded on a vehicle;
an identifier specific to the sensor used.

Each tracking list is preferably according to the CPM (Collective Perception Message) format, as for example described in the document titled “L 1.2C: SPECIFICATION DU SYSTEME ET DE SES COMPOSANTS—FORMAT DES MESSAGES (Specification of the system and its components—Message Formats)”, in its version V03 published on Dec. 12, 2017.

In particular, it should be noted that:

said at least one received monitoring information item by road corresponds:
directly to at least part of the tracking list by road with which said at least one received monitoring information item by road is associated, or
to a movement limiting setpoint for each vehicle located in a geographical area in which the traffic element is located associated with said at least one monitoring information item by road, the movement limiting setpoint being calculated as a function of at least the tracking list by road with which said at least one received monitoring information item by road is associated,

and/or that said at least one received monitoring information item by vehicle corresponds:
directly to at least part of the tracking list by vehicle with which said at least one received monitoring information item by vehicle is associated, or
to a movement limiting setpoint for each vehicle located in a geographical area in which the traffic element is located associated with said at least one monitoring information item by vehicle, the movement limiting setpoint being calculated as a function of at least the tracking list by vehicle with which said at least one received monitoring information item by vehicle is associated.

Each traffic element 31 is an element able to circulate in and/or cross a respective traffic lane 24. Each traffic element 31 is in particular an element able to be located in the geographical zone associated with the vehicle infrastructure monitored by the platform 14. Each traffic element 31 is for example chosen from the group consisting of: a motorized vehicle, such as a motor vehicle 12; a nonmotorized vehicle; a pedestrian and an animal.

Each sensor, whether it is a road sensor C₁ or a sensor 16 embedded in a vehicle 12_{A}, is in fact associated with a module (not shown) for determining such a tracking list for at least one traffic element detected via the considered sensor, the traffic element being located within a geographical area covered by the corresponding sensor.

For example, in FIG. 1, the traffic element 31 is a pedestrian traveling in the field of view F of the sensor C₁.

The determining module is for example located within the communication terminal T₁ and configured to determine the tracking list from the measured value(s) supplied, via a link, for example wired, L₁ by the sensor C₁ relative to the detected traffic element 31, or supplied, via a link, for example wireless (not shown), by the sensor 16 embedded in the vehicle 12_{A}. This determination of information element(s), of the type previously described and from value(s) measured by the sensor C₁, or by the sensor 16, is known in itself. One skilled in the art will further understand that each measured value is to be understood broadly within the meaning of a measurement done by the sensor C₁ relative to the traffic element 31, and depends on the type of the sensor C₁.

When the sensor C₁ is an image sensor, the measured value supplied by the sensor C₁ is in particular an image of a scene comprising the traffic element 31, or in other words an image of the geographical area inside which the traffic element 31 is located.

When the sensor C₁ is a lidar, a leddar, or radar or an ultrasonic sensor, the measured value supplied by the sensor C₁ is in particular a set of measuring point(s) of the scene comprising the traffic element 31, or in other words a set of measuring point(s) of the geographical area inside which the traffic element 31 is located. As is known in itself, this set of measuring point(s), also called measuring scatter diagram, is obtained by the sensor 31 via the sending of a plurality of measuring signals in different sending directions, then the reception of signals resulting from the reflection, by the environment, of the sent measuring signals, the sent measuring signals typically being light, radio or ultrasonic signals.

As previously indicated, according to a first variant, the monitoring information by road and/or the monitoring information by vehicle corresponds directly to at least part of the tracking list by vehicle with which said at least one received monitoring information item is associated. Thus, the load of the datalink with the remote electronic item is taken into account, and the sending module transmits an appropriate quantity of information elements.

According to a second variant, the monitoring information by road and/or the monitoring information by vehicle corresponds to a movement limiting setpoint for each vehicle located in a geographical area in which the traffic element is located associated with said at least one monitoring information item. The quantity of information thus transmitted to the monitoring platform is then reduced relative to the state of the art, where all of the information items contained in the determined tracking list(s) are sent. Each movement limiting setpoint indeed has a data size, for example expressed in bits or bytes, smaller than the size of the tracking list(s) from which it is calculated.

Indeed, according to one particular aspect, the communication terminal T₁ optionally comprises a computing module (not shown) configured to compute, as a function of at least one tracking list determined by the aforementioned determining module, a movement limiting setpoint for each vehicle located in the geographical area, and/or the communication terminal T₁ optionally comprises a switching module configured to switch the communication terminal T₁ sending module between a first sending mode according to which the sending module transmits the limiting setpoint(s) calculated when the calculating module of the communication terminal T₁ is optionally present, and a second sending mode having a main sending switching state in which the sending module transmits all of the information elements of a set of tracking lists to the monitoring platform 14 and optionally a secondary sending switching state in which the sending module of the communication terminal T₁ sends only a portion of the information elements of the set of tracking lists to the electronic monitoring equipment.

“Portion” means that in the optional secondary switching state of the second sending mode, the sending module is configured to transmit, for each tracking list, a number of information elements less than or equal to a predetermined element threshold N (that is to say, for example, in this case the transmitted portion corresponds to the first N elements of the tracking list), and/or to transmit only a portion of each tracking list, the transmitted portion of each tracking list comprising a number of information elements lower than the total number of information elements contained in said tracking list.

According to one particular aspect, such an optional switching module is in particular configured to evaluate a load of the datalink between the sending module and the electronic monitoring equipment, and to switch the sending module optionally to the first sending mode, or optionally to the secondary state of the second sending mode if a load of the datalink is detected above a predefined load threshold.

According to one particular aspect, the determining module is configured to merge at least two tracking lists into one comprehensive tracking list, the merged tracking lists preferably being associated with traffic elements of the same type, for example for a group of pedestrians circulating at substantially the same speed and located in a reduced geographical area.

According to another optional complementary aspect, the communication terminal T₁ comprises, in addition to the aforementioned optional computing module, an acquisition module (not shown) configured to acquire at least one setpoint computing rule, from an electronic device, preferably from the monitoring platform 14; and in this case the computing module is configured to compute the movement limiting setpoint further as a function of the at least one acquired computing rule, the movement limiting setpoint being chosen from the group consisting of: a speed limiting setpoint, an acceleration limiting setpoint; and a speed and acceleration limiting setpoint.

It should be noted that each tracking list is determined, by the determining module of the communication terminal T₁ associated with a sensor, relative to a coordinate system specific to the sensor in question.

According to the present invention, at the synthesis tool 28 of the platform 14, the first receiving and processing module 30 and the second receiving and processing module 32 of the synthesis tool 28 of the platform 14 are respectively configured to convert the information elements of each received monitoring information item, whether by road or by vehicle, in a common coordinate system, such as the Earth's coordinate system or the geocentric coordinate system in order to allow the synthesis tool 28 to deliver a synthesis information item from comparable information elements.

According to a first specific variant of the invention, the first receiving and processing module 30 and the second receiving and processing module 32 correspond to a same receiving and processing module (that is to say, are combined in a single module).

According to a second specific variant of the invention, the first receiving and processing module 30 and the second receiving and processing module 32 are separate modules able to operate in parallel and to use dedicated communication links of different natures, for example wired links L_{c} for the first receiving and processing module 30 able to receive and process at least one road monitoring information item, and wireless links L_{V} (optionally secure) for the second receiving and processing module 32.

As an optional addition, the synthesis tool 28 further comprises a display module 34 configured to display, simultaneously in an image representative of at least part of the infrastructure:
at least one road perception, representative of the state of the traffic element associated with said at least one monitoring information item by road, the road perception being determined from said at least one monitoring information item by road, and
at least one vehicle perception, representative of the state of the traffic element associated with said at least one monitoring information item by vehicle, the vehicle perception being determined from said at least one monitoring information item by vehicle.

According to one optional complementary aspect, the display module 34 capable, according to the invention, of simultaneously displaying, on an image representative of at least a portion of the infrastructure, both at least one road perception and at least one vehicle perception, is also capable of retrieving only one or several road perception(s) simultaneously or only one or several vehicle perception(s) simultaneously, the retrieval mode being able to be selected by the human operator located within the monitoring platform 14.

Such an image is two-dimensional, as shown and described hereinafter in relation with FIG. 2, or three-dimensional.

In other words, such a display module 34 is configured to build a synthetic image of the current traffic situation. To that end, such a module is for example able to superimpose, simultaneously, on the image representative of at least a portion of the infrastructure, at least one state of the traffic element associated with said at least one monitoring information item by road and at least one state of the traffic element associated with said at least one monitoring information item by vehicle.

According to one particular aspect, such states of the traffic element associated with said at least one monitoring information item by road and the traffic element associated with said at least one monitoring information item by vehicle correspond directly to the monitoring information item that is associated with them, namely respectively, according to this particular aspect, a movement limiting setpoint for each vehicle located in a geographical area in which the traffic element associated with said at least one monitoring information item by road is located and a movement limiting setpoint for each vehicle located in a geographical area in which the traffic element associated with said at least one monitoring information item by vehicle is located. According to this particular aspect, the obtained limiting setpoint(s) are able to be retrieved by the display module 34 superimposed on the synthetic two-dimensional image using a predetermined speed limiting indicator known by the human operator located within the supervision platform 14.

As an optional addition, the display module 34 is associated with a sound information retrieval module (not shown) able to retrieve a portion of the road and/or vehicle perceptions obtained in sound form so as to lighten the synthetic image built via the display module 34.

According to one specific variant, such a display module 34 is also able, at a current moment, to superimpose, on the image representative of at least a portion of the infrastructure, the field of view of each of the sensors having provided, at the current instant, each monitoring information item by road or by vehicle.

According to another specific complementary and/or optional variant, the display module 34 is configured to provide a dynamic display able to update in case of variation exceeding a predetermined threshold of the value of said at least one monitoring information item by road received between two separate instants or the value of said at least one monitoring information item by vehicle received between two separate instants.

In particular, such a predetermined threshold for the value of said at least one monitoring information item by road or by vehicle is respectively able to increase in proportion to the duration, separating the two separate reception moments of a monitoring information item by road relating to the same traffic element, or separating the two separate reception instants of a monitoring information item by vehicle relating to the same traffic element.

According to an optional complementary aspect, the synthesis tool 28 of the platform further comprises a synchronization module 36 configured to synchronize said at least one monitoring information item by road and said at least one monitoring information item by vehicle when they are associated with the same traffic element.

In particular, such a synchronization module 36 comprises a comparison instrument for timestamping information respectively provided by a monitoring apparatus on the road or by a monitoring apparatus embedded in a vehicle.

According to another optional complementary aspect, the platform further comprises a module 38 for generating and sending an instruction to a target vehicle able to follow a predefined path on the infrastructure, the instruction being determined from said at least one monitoring information item by road and from said at least one monitoring information item by vehicle.

For example, as previously indicated, from said at least one monitoring information item by road and from said at least one monitoring information item by vehicle, a synthetic image of the state of the traffic in real time on at least a portion of the transport infrastructure is obtained by the display module 34, and the instruction intended for a target vehicle is generated taking account of such a synthetic image.

According to one particular aspect, an instruction is generated from an order entered by a human operator, via an entry interface of the monitoring platform 14, the human operator defining such an order by viewing the synthetic image obtained according to the present invention.

According to a variant, an instruction is generated automatically from information shown on the synthetic image obtained according to the invention and the position of the target vehicle.

To that end, one or several predetermined automatic generating rules are taken into account by the generating and transmission module 38. For example, a first automatic generating rule is activated if a traffic element, corresponding to a pedestrian, is detected (by road and/or by vehicle) in a predetermined location, for example in the middle of a traffic lane and during a predetermined time range to produce a slowing instruction intended for the target vehicle(s) moving along a predetermined path toward said predetermined location and an alert for the human operator located within the monitoring platform 14.

A second automatic generating rule is activated if a traffic element, corresponding to a pedestrian, is detected (by road and/or by vehicle) with an abnormal behavior such as a state of drunkenness that may influence his own movement behavior during a predetermined time window, in order to produce a slowing instruction intended for the target vehicle(s) moving along a predetermined path near the presence area of the traffic element with the abnormal behavior and an alert intended for the human operator located within the monitoring platform 14.

“Near” refers to a location separated by a distance of less than or equal to substantially 50 m from the presence area of the traffic element with the abnormal behavior.

A third automatic generating rule is activated if a traffic element, corresponding to a vehicle, is detected (by road and/or by vehicle) exceeding the speed limit within the monitored infrastructure area in order to produce a slowing instruction intended for the target vehicle(s) moving along a predetermined path near the presence area of the speeding traffic element and an alert intended for the human operator located within the monitoring platform 14.

“Near” refers to a location separated by a distance of less than or equal to substantially 50 m from the presence area of the speeding traffic element.

A fourth automatic generating rule is activated if an abrupt change of speed is detected in the speed of a traffic element in order to produce a slowing instruction intended for the target vehicle(s) moving along a predetermined path near the presence area of such a traffic element whose speed variation is abrupt.

“Abrupt change of speed” refers to a speed variation exceeding a predetermined variation threshold over a predetermined variation period.

According to the knowledge of those skilled in the art in terms of traffic and associated traffic risks, a plurality of other predetermined rules can also be taken into account by the generating and transmission module 38 in order to automatically generate a guiding instruction of a target vehicle from information reported on the synthetic image obtained according to the invention and the position of the target vehicle.

In the example of FIG. 1, the target vehicle 12_{A} comprises an information processing unit 40, for example made up of a memory 42 and a processor 44 associated with the memory 42.

In the example of FIG. 1, the geolocation module 20, the autonomous driving module 22 and the receiving and processing module 26 are each made in the form of software, or a software component, executable by the processor 44.

The memory 42 of the target vehicle 12_{A} is then suitable for storing first geolocation software to allow the geolocation of the target vehicle 12_{A}, second autonomous driving software suitable for driving the autonomous vehicle autonomously by receiving information on the environment of the autonomous vehicle 12_{A} via sensors, located outside or inside the autonomous vehicle, and acting on the engine (not shown), the steering system (not shown) and the braking system (not shown) so as to modify the speed and the path of the autonomous vehicle 12_{A} in response to the received information and so as to comply with a mission programmed into the logic controller, third receiving and processing software configured to receive and process a driving setpoint sent by the monitoring platform 14.

The processor 44 is then able to execute each software from among the first geolocation software, the second autonomous driving software, the third software for receiving and processing a driving setpoint sent by the monitoring platform 14.

In a variant that is not shown, the geolocation module 20, the autonomous driving module 22, the receiving and processing module 26 are each made in the form of a programmable logic component, such as an FPGA (Field Programmable Gate Array), or in the form of a dedicated integrated circuit, such as an ASIC (Application Specific Integrated Circuit).

When a portion of the autonomous vehicle 12_{A} is made in the form of one or several software programs, i.e., in the form of a computer program, this portion is further able to be stored on a medium, not shown, readable by computer. The computer-readable medium is for example a medium suitable for storing electronic instructions and able to be coupled with a bus of a computer system. As an example, the readable medium is an optical disc, a CD-ROM, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

In the example of FIG. 1, the geolocation module 20, the autonomous driving module 22, the receiving and processing module 26 are embedded within only the information processing unit 40, that is to say, within a single and same electronic computer of the autonomous vehicle 12_{A}.

Similarly, in the example of FIG. 1, the monitoring platform 14 also comprises an information processing unit 46, for example made up of a memory 48 and a processor 50 associated with the memory 48.

In the example of FIG. 1, the optional module 38 for generating and transmitting an instruction to a target vehicle as well as the synthesis tool 28 and its modules, namely the first receiving and processing module 30, the second receiving and processing module 32, the optional display module 34, the optional synchronization module 36, are each made in the form of software, or a software component, executable by the processor 50.

The memory 48 of the monitoring platform 14 is then able to store optional software for generating and transmitting an instruction, the instruction being determined from said at least one monitoring information item by road and from said at least one monitoring information item by vehicle, and synthesis software able to process at least one monitoring information item by road and at least one monitoring information item by vehicle.

The processor 50 is then able to execute the optional software for generating and transmitting an instruction, the synthesis software and the software modules that it comprises.

In a variant not shown, the optional module 38 for generating and transmitting an instruction to a target vehicle as well as the synthesis tool 28 and its modules, namely the first receiving and processing module 30, the second receiving and processing module 32, the optional display module 34, the optional synchronization module 36, are each made in the form of a programmable logic component, such as an FPGA (Field Programmable Gate Array), or in the form of a dedicated integrated circuit, such as an ASIC (Application Specific Integrated Circuit).

When a portion of the monitoring platform 14 is made in the form of one or several software programs, i.e., in the form of a computer program, this portion is further able to be stored on a medium, not shown, readable by computer. The computer-readable medium is for example a medium suitable for storing electronic instructions and able to be coupled with a bus of a computer system. As an example, the readable medium is an optical disc, a CD-ROM, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

In the example of FIG. 1, the optional module 38 for generating and transmitting an instruction to a target vehicle as well as the synthesis tool 28 and its modules, namely the first receiving and processing module 30, the second receiving and processing module 32, the optional display module 34, the optional synchronization module 36 within only the information processing unit 46, that is to say, within a single and same electronic computer of the autonomous vehicle 12_{A}.

FIG. 2 is an exemplary synthetic two-dimensional image produced by the display module 34 of the synthesis tool 28 of the monitoring platform 14 according to the invention.

Such an image in particular corresponds to a plane I of a portion of the transport infrastructure in which an autonomous vehicle 12_{A} is in the process of moving at an instant t.

The autonomous vehicle 12_{A} automatically (that is to say, without human intervention) transmits, for example to the monitoring platform 14, via the link L_{V}, illustrated in FIG. 1, a request to confirm its predefined itinerary, or to confirm its speed.

To help a human operator located within the monitoring platform 14 to respond to this request, the synthesis tool 28 of the platform 14 recovers, via its second receiving and processing module 32, at least one monitoring information item by vehicle transmitted by the communication terminal T₁, embedded in this vehicle 12_{A}, and associated with the sensor 16, and, via its first receiving and processing module 30, at least one monitoring information item by road respectively transmitted by the communication terminal T₁ associated with the sensor C₁ (not shown) of the monitoring apparatus A₁, and at least one monitoring information item by road respectively transmitted by the communication terminal T₂ associated with the sensor C₂ (not shown) of the monitoring apparatus A₂.

As previously indicated, these monitoring information items are respectively obtained from tracking lists determined, by the determining module of the communication terminal T₁ associated with the considered sensor, and relative to a coordinate system specific to the sensor in question.

According to the present invention, at the synthesis tool 28 of the platform 14, the first receiving and processing module 30 and the second receiving and processing module 32 of the synthesis tool 28 of the platform 14 are respectively configured to convert the information elements of each received monitoring information item, whether by road or by vehicle, in a common coordinate system, such as the Earth's coordinate system.

To build the synthetic image of FIG. 2, such elements, converted in a common coordinate system, are next automatically carried over by the display module 34 superimposed on the synthetic image of FIG. 2.

More specifically, the sensor 16 embedded in the vehicle 12_{A}, at the instant t±Δt, Δt being predetermined and if applicable configured manually by a human operator located within the platform 14, has detected several traffic elements, namely the vehicle 12₁ characterized by a movement vector V₁ whose length is proportional to its speed, and the pedestrian 31₁.

According to the invention, the monitoring information items by vehicle respectively associated with the traffic elements corresponding to the vehicle 12₁ and the pedestrian 31₁ are therefore carried over, after reception and processing, onto the synthetic image of FIG. 2.

The range P₁ of the sensor 16 is, according to one optional aspect, also shown in the synthetic image. As an alternative (not shown), the actual field of view of the sensor 16 is shown in the form of a polygon delimited by a broken line as a function of the obstructions of this field of view, for example the building B1 or the building B2.

The road sensor C₁ of the monitoring apparatus A₁, for example a lidar placed in the center of a roundabout and having a field of view of 360° and a range P₂, at the instant t±Δt, Δt being predetermined and if applicable configured manually by a human operator located within the platform 14, has detected several traffic elements, namely the vehicles 12₂ to 12₅ corresponding to four-wheeled vehicles each depicted using rectangles, or to two-wheeled vehicles each depicted by a dot, characterized by their respective movement vector V₂ to V₅, the length of which is proportional to their respective speed, and the pedestrians 31₂ to 31₄. In particular, the vehicle 12₃, here an automobile, is characterized by a nil speed vector, indicating that it is stopped in the roundabout, which potentially constitutes an element disrupting traffic.

Similarly, the road sensor C₂ of the monitoring apparatus A₂, for example a lidar placed near the intersection between two traffic lanes and having a field of view of 360° and a range P₃ at the instant t±Δt, has simultaneously detected several traffic elements, namely the vehicle 12₆ corresponding to a four-wheeled vehicle depicted using a rectangle and characterized by a movement vector V₆ whose length is proportional to its speed, and the pedestrians 31₅ and 31₆.

Advantageously, all of these traffic elements detected by a road sensor C₁ and a sensor 16 embedded in a vehicle are all uniformly reflected in the synthetic image of FIG. 2, which allows a human operator viewing such an image within the monitoring platform 14 to apprehend the current traffic situation quickly in order to determine, practically instantaneously, the guidance instructions to be transmitted to the autonomous vehicle 12_{A}.

In particular, the vehicle 12₆ has a speed in excess of the authorized speed limit.

Such an excess speed is, according to a first embodiment variant, directly able to be determined by the terminal T₂, associated with the sensor C₂, or according to a second variant, able to be determined by the first receiving and processing module 30 of the monitoring platform 14, or according to a third variant able to be determined by the display module 34, by respectively comparing the measured speed value, or processed speed value or length of the speed vector to a value representative of the speed limit applicable in the traffic area d.

According to one particular aspect, the display module 34 is able to retrieve such an excess speed of the vehicle 12₆ or to retrieve the stopping of the vehicle 12₃, respectively by displaying an excess speed/stopping message superimposed on the synthetic image near the vehicle 12₆/12₃ or by adding an excess speed/stopping indicator superimposed on the synthetic image, or by making the speed vector of this vehicle or the vehicle itself blink.

The assembly formed by the vehicle 12₆, its movement vector and optionally the message/indicator/animation representative of the excess speed of this vehicle constitutes a “road perception” according to the present invention. Similarly, a “vehicle perception” is also formed, for example, by the vehicle 12₁ and its movement vector as obtained from the corresponding traffic element detected by the sensor 16 embedded in the autonomous vehicle 12_{A}.

In the presence of all of these traffic elements obtained both from road sensor(s) and embedded sensor(s) carried over into the two-dimensional plane in order to form a synthetic image of the current traffic situation retrieved within the monitoring platform 14, a human operator is assisted practically in real time in his decision-making to respond to the request from the autonomous vehicle 12_{A}.

For example, in light of the vehicle 12₃ stopped in the roundabout and the vehicle 12₆ speeding in the synthetic image delivered by the synthesis tool of the monitoring platform 14 according to the invention, the operator determines a potential collision risk, or at least that it is necessary to slow down the autonomous vehicle 12_{A} or to modify its itinerary and enters a corresponding traffic order using the interface means within the platform 14. Such an order is next converted and transmitted to the autonomous vehicle 12_{A} via the generating and transmitting module 38 of the monitoring platform 14 according to the present invention.

The operation of the monitoring platform 14 according to the invention will now be explained in light of FIG. 3 showing a flowchart of the method 52, according to the invention, the method being implemented by the monitoring platform 14.

During a step 54, the synthesis tool 28 of the monitoring platform 14 according to the invention implements, via its first receiving and processing module 30, the reception and processing of at least one monitoring information item by road, each monitoring information item by road being determined from a tracking list by road including several information elements associated with a traffic element detected via a sensor installed along the public road network of the infrastructure.

In parallel or independently, during a step 56, the synthesis tool 28 of the monitoring platform 14 according to the invention implements, via its second receiving and processing module 32, the reception and processing of at least one monitoring information item by vehicle, each monitoring information item by vehicle being determined from a tracking list by vehicle including several information elements associated with a traffic element detected via a sensor installed in a vehicle traveling on the infrastructure.

When, as an optional addition, the synthesis tool 28 of the platform 14 further comprises the synchronization module 36, the platform 14 then synchronizes, during step 58, via this synchronization module 36, said at least one monitoring information item by road and said at least one monitoring information item by vehicle when they are associated with the same traffic element.

When, as an optional addition, the synthesis tool 28 of the platform 14 further comprises the display module 34, the platform 14 then displays, according to step 60, simultaneously in an image representative of at least part of the infrastructure:

at least one road perception, representative of the state of the traffic element associated with said at least one monitoring information item by road, the road perception being determined from said at least one monitoring information item by road, and

at least one vehicle perception, representative of the state of the traffic element associated with said at least one monitoring information item by vehicle, the vehicle perception being determined from said at least one monitoring information item by vehicle.

Optionally, the display step 60 comprises a sub-step 62 for updating the current display such as the synthetic image previously described, in case of variation exceeding a predetermined threshold of the value of said at least one monitoring information item by road received between two separate instants or the value of said at least one monitoring information item by vehicle received between two separate instants.

Lastly, when, as an optional addition, the platform 14 further comprises the module for generating and transmission 38, during a step 64, the platform 14 generates and transmits, via the generating and transmission module 38, an instruction to a target vehicle able to follow a predefined path on the infrastructure, the instruction being determined from said at least one monitoring information item by road and from said at least one monitoring information item by vehicle.

One can thus see that the monitoring platform 14, which is able to process both monitoring information items by road and monitoring information items by vehicle simultaneously, is able, via its synthesis tool 28, to retrieve, practically in real time and with precision, the current traffic situation, which allows a human operator to anticipate potential traffic difficulties more effectively and with increased reactivity in order to make relevant vehicle guidance decisions and/or to make a module for automatically generating guidance instructions integrated into the synthesis tool 28 that is more reliable and more efficient.

1. A platform for monitoring an infrastructure for transport vehicles wherein the platform comprises a synthesis tool comprising at least:
a first receiving and processing module configured to receive and process at least one monitoring information item by road, each monitoring information item by road being determined from a tracking list by road including several information elements associated with a traffic element detected via a sensor installed along the public road network of the infrastructure, and
a second receiving and processing module configured to receive and process at least one monitoring information item by vehicle, each monitoring information item by vehicle being determined from a tracking list by vehicle including several information elements associated with a traffic element detected via a sensor installed on board a vehicle traveling on the infrastructure.

2. The platform according to claim 1, wherein the synthesis tool further comprises a display module configured to display, simultaneously in an image representative of at least part of the infrastructure:
at least one road perception, representative of the state of the traffic element associated with said at least one monitoring information item by road, the road perception being determined from said at least one monitoring information item by road, and
at least one vehicle perception, representative of the state of the traffic element associated with said at least one monitoring information item by vehicle, the vehicle perception being determined from said at least one monitoring information item by vehicle.

3. The platform according to claim 2, wherein the display module is configured to provide a dynamic display able to update in case of variation exceeding a predetermined threshold of the value of said at least one monitoring information item by road received between two separate instants or the value of said at least one monitoring information item by vehicle received between two separate instants.

4. The platform according to claim 1, wherein the synthesis tool further comprises a synchronization module configured to synchronize said at least one monitoring information item by road and said at least one monitoring information item by vehicle when they are associated with the same traffic element.

5. The platform according to claim 1, wherein the tracking list associated with said at least one monitoring information item by road and/or the tracking list associated with said at least one monitoring information item by vehicle comprises a plurality of information items chosen from the group consisting of:
the type of traffic element,
the position of the traffic element,
at least one dimension of the traffic element;
a speed of the traffic element; and
a confidence index associated with the traffic element.

6. The platform according to claim 1, wherein said at least one received monitoring information item by road corresponds:
directly to at least part of the tracking list by road with which said at least one received monitoring information item by road is associated, or
to a movement limiting setpoint for each vehicle located in a geographical area in which the traffic element is located associated with said at least one monitoring information item by road, the movement limiting setpoint being calculated as a function of at least the tracking list by road with which said at least one received monitoring information item by road is associated,
and/or wherein said at least one received monitoring information item by vehicle corresponds:
directly to at least part of the tracking list by vehicle with which said at least one received monitoring information item by vehicle is associated, or
to a movement limiting setpoint for each vehicle located in a geographical area in which the traffic element is located associated with said at least one monitoring information item by vehicle, the movement limiting setpoint being calculated as a function of at least the tracking list by vehicle with which said at least one received monitoring information item by vehicle is associated.

7. The platform according to claim 1, the platform further comprising a module for generating and sending an instruction to a target vehicle able to follow a predefined path on the infrastructure, the instruction being determined from said at least one monitoring information item by road and from said at least one monitoring information item by vehicle.

8. A transport system comprising a fleet of vehicles, in particular autonomous vehicles, able to move on an infrastructure for transport vehicles, the fleet of vehicles comprising at least one target vehicle able to follow a predefined path on the infrastructure, wherein the transport system further comprises such a monitoring platform according to claim 1.

9. A method for monitoring an infrastructure for transport vehicles, the method being implemented by a synthesis tool of a monitoring platform of the infrastructure, the method comprising:
a first step for receiving and processing at least one monitoring information item by road, each monitoring information item by road being determined from a tracking list by road including several information elements associated with a traffic element detected via a sensor installed along the public road network of the infrastructure,
a second step for receiving and processing at least one monitoring information item by vehicle, each monitoring information item by vehicle being determined from a tracking list by vehicle including several information elements associated with a traffic element detected via a sensor installed on board a vehicle traveling on the infrastructure.

10. A computer program product comprising software instructions which, when executed by a computer, carry out a supervision method according to claim 9.
